(19) United States
(12) Patent Application Publication
(10) Pub. No.: US 2009/0303708 A1
(43) Pub. Date: Dec. 10, 2009

(54) Illumination System

(75) Inventors: Petrus A.J. Holten, Aalten (NL); Paulus G. H. Kosters, Eindhoven (NL); Denis J. C. Van Oers, Eindhoven (NL); Erik Boonekamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N V, Eindhoven (NL)

(21) Appl. No.: 12/297,755

(22) PCT Filed: Apr. 10, 2007
(86) PCT No.: PCT/IB2007/051281

§ 371 Date: Jul. 29, 2009

(30) Foreign Application Priority Data
Apr. 21, 2006 (EP) 06112875.7

(51) Int. Cl. F21V 9/00; F21V 1/00

(52) U.S. Cl. 362/231; 362/235

(57) ABSTRACT

An illumination system comprising at least two closely arranged light sources, each emitting a unique light spectrum during operation, and an optical system (1). The optical system comprises a light guide (4) with an incoupling face (6) and an outcoupling face (7). The optical system further comprises a mirroring transition part (8) connecting the outcoupling face of the light guide with a transparent light extraction panel (9). The transparent light extraction panel has an extraction structure (11) for outcoupling of light to the exterior. The light guide and the extraction means are specular reflective, the mirror preferably being about specular reflective. Compared to the known illumination systems the illumination system of the invention is both relatively efficient and has an improved control of the light beam.

The invention relates to an illumination system according to the preamble of claim 1.

Such an illumination system is known from JP2005-183124A. In the known illumination system, a diffuser is used to mix light of different spectra so as to cause the system to output a homogeneously mixed spectrum, and also to make the individual light sources indistinguishable from the exterior. The light beams of the light sources of said known system are mixed and diffused in the optical waveguide, resulting in a non-collimated beam of light having a Lambertian spatial light intensity distribution. The diffused light has to be coupled into the transition part and subsequently into the light extraction panel. A Lambertian spatial distribution is an optical light distribution that obeys Lambert's cosine law, i.e. that has an intensity directly proportional to the cosine of the angle from which it is viewed. When the illumination system is used for general lighting purposes and has a transparent light extraction panel to distribute light to the exterior, it is unfavorable to have said Lambertian light distribution of the outputted light beam. Such a Lambertian distribution leads to the disadvantages of glare and emission of light in undesired directions, or even in directions that fall outside the limits for the amount of disturbing light for observers in lighting applications as mentioned in the EN12464 standard, for example for office lighting. Another disadvantage is that the coupling of diffused light into the transition part and subsequently into the light extraction panel is relatively inefficient.

It is an object of the invention to provide an illumination system in which the abovementioned disadvantages are counteracted. The illumination system of the type as mentioned in the opening paragraph is for this purpose characterized by the characterizing portion of claim 1. The term “neighboring” in this respect is to be understood to mean that the greatest mutual distance of the light sources is smaller than half the length of the optical waveguide, for example ⅓, ¼ or ⅛. In the inventive illumination system, color mixing is obtained essentially through substantially specular reflection in the transition part, thus offering the advantage that the mixed light beam generated by the illumination system has retained its collimated properties to a large extent. Compared with the known illumination system, this makes the illumination system of the invention relatively efficient and provides an improved control of the light beam as regards glare and emission in undesired directions. Generally, diffuse reflection causes an increase in the angular spread α of the light beam of more than 90°, but it results in the abovementioned disadvantages of the known illumination system. In this respect the increase in angular spread α is to be understood to be the increase in the spread angle of the half-width value of the intensity of the light beam after it has been reflected, i.e. the spread angle of the reflected beam minus the spread angle of the incident beam. Theoretically α is zero for perfect specular reflection the angular spread, but in practice perfect specular reflection is never obtained. This means that after each reflection of a light beam a small increase in angular spread α is obtained, but this angular spread α is not observable to the human eye. The expression specular reflection is generally accepted to denote the abovementioned phenomenon. Since the illumination system according to the invention is based on specular reflection, the number of reflections of the light beam has to be relatively large in order to cause the images of the individual sources to overlap each other sufficiently for forming one secondary source with the mixed qualities of the individual ones present in the overlap. The transition means has to be located at a certain minimum distance to achieve this in the case of specular reflection. When an angular spread α of, for example, 0.1° is assumed for specular reflection and the light sources are spaced apart by 10 mm, the transition part has to be positioned at a distance of more than 5700 mm from the light sources. Hence, the optical waveguide has to have a length of 5700 mm for the individual light sources for them to be homogeneously mixed to a satisfactory degree by the specularly reflecting transition part, the light sources nevertheless being relatively close to each other.

Experiments have shown that said minimum distance can be significantly reduced and the homogeneity of the emitted mixed light beam is improved when the transition part is virtually specularly reflecting, while the optical waveguide and the light extraction panel can still be specularly reflecting. It is thus counteracted that the illumination system is too spacious, i.e. in that the optical waveguide is too long. In this respect virtually specular(ly) is to be understood to mean that the reflected light beam has an increase in the angular spread α of at least 5°. An angular spread α of 5° enables the optical waveguide to have a length of about 300 mm for light sources that are spaced apart by 30 mm, while the illumination system still provides a satisfactory optical mixing of the individual spectra.

Experiments have shown that the increase in angular spread α upon reflection can be at most 30° if the requirement for the beam characteristics to stay within the EN12464 standard is still complied with. In an illumination system with the light sources spaced apart by 30 mm, such an increase in angular spread α allows an even greater size reduction of the optical waveguide to, for example, approximately 100 mm, if so desired, while the EN12464 standard is still complied with. The increase in angular spread α of 30° is realized by a treatment of the reflector, for example of the reflecting surface of the reflector, for example by chemical etching, or by coating the reflector with a partly specularly reflecting coating. Sandblasting is not preferred as a method of producing the diffusely reflecting surface as it results in the undesired Lambertian spatial distribution of light. If the increase in angular spread α is more than 30°, the light propagation will be disturbed too much and cause too much light leakage and light extraction in undesired directions to the extent that the EN12464 standard is no longer complied with. Both the optical waveguide and the light extraction panel may be hollow, tubular bodies with (virtually) specularly reflecting walls, or solid, transparent bodies with total internal reflection (TIR).

Suitable transition parts are bent, slightly diffusing, optical glass fibers having total internal reflection (TIR), PMMA fibers, solid TIR deflector/reflector mirrors, or open reflector mirrors. A preferred embodiment of the illumination system is characterized in that the transition part is formed by one or more open reflection mirrors. This is comparatively inexpensive, and the increase in angular spread α is controlled by the reflecting surface structure of the mirror only, and not by the quality of the solid body and the path length of the light beams through said solid body.

The transition part is located in between the optical waveguide (supply part) of the illumination system and the light extraction panel. The transition part may comprise one, two or more deflection/reflection mirrors. An embodiment with a 0° propagation angle of light is an interesting configuration for e.g. false ceilings, where only the light extraction panel of the illumination system is visible and the other illumination system parts, i.e. the optical waveguide and the transition part, are hidden, for example behind a ceiling panel. The propagation angle is to be understood as the angle between the longitudinal optical waveguide axis of the optical waveguide and the longitudinal panel axis of the light extraction panel.

An embodiment with a 90° propagation angle of light is an interesting configuration for e.g. floor standing or desktop luminaires, where the light generation part is mounted to the bottom part, the flat transparent panel may function as a light-guiding pole, and the extraction panel functions as the light-emitting surface, for example embodied as a standing luminaire with both direct light and indirect light.

An embodiment with a 180° propagation angle, i.e. in which the light propagation (and mounting) is reversed, the light-generating part may be at the ceiling while the optical waveguide and the extraction panel may be present as a floating element in the room, for example as a suspended luminaires This embodiment is interesting where reduced overall dimensions are important. Also, the optical waveguide may serve as a protection cover for the light extraction panel in this configuration. Intermediate angles are possible as well, depending on the desired configuration.

Suitable materials for the optical waveguide are PMMA and glass with a relatively low level of absorption of visible radiation. In this respect PC is not preferred because of its relatively high absorption of visible radiation. Suitable extraction means are, for example, Fresnel patterns, locally roughened surfaces, diffusely applied transparent inks, or dots of white paint. The transition part has a reflecting surface, for example of aluminum, partly specularly reflecting coatings, or a chemically etched surface. Suitable light sources have a relatively small size in at least two dimensions. Suitable light sources are, for example, LEDs in the primary colors red, green and blue (RGB), white or amber, halogen lamps, HID lamps, fluorescent tubes of different primary colors, e.g. RGB or having different color temperatures (W), for example 2500 K and 5600 K.

A favorable embodiment is characterized in that the transition part comprises at least two mutually rotatable deflection/reflection mirrors. It is thus realized that the light propagation can be guided into any desired direction within any solid angle.

EP-1243847 discloses a luminaire with a reflector coated with a reflecting coating with light-reflecting particles. The coating has a smooth optical wave-guiding surface due to the absence of said particles at the outer surface of the coating. This results in the coating to be partly specularly reflecting. The degree of specular reflection can be controlled by the amount and location of reflecting particles in the coating.

The invention will be further explained and elucidated by means of the drawing in which

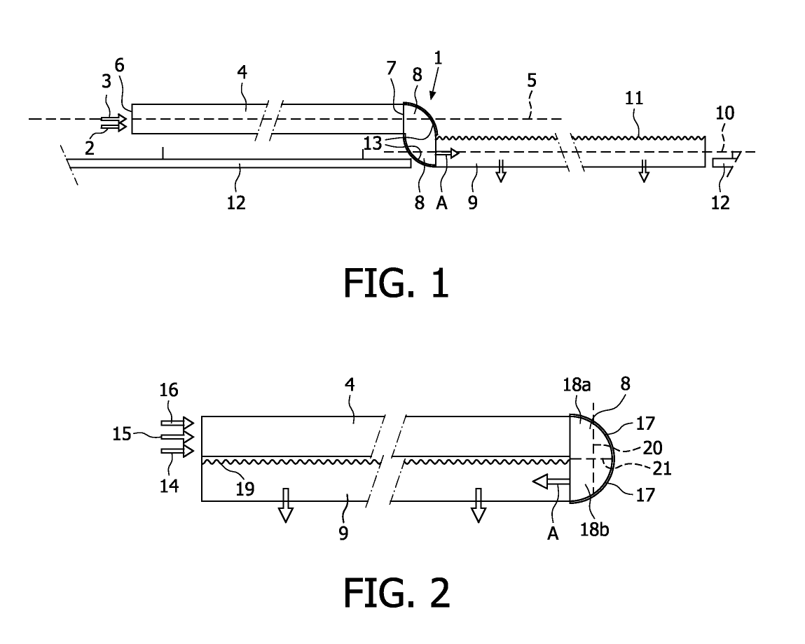

FIG. 1 is a side elevation of a first embodiment of the illumination system according to the invention,

FIG. 2 shows a second embodiment of the illumination system of the invention, and

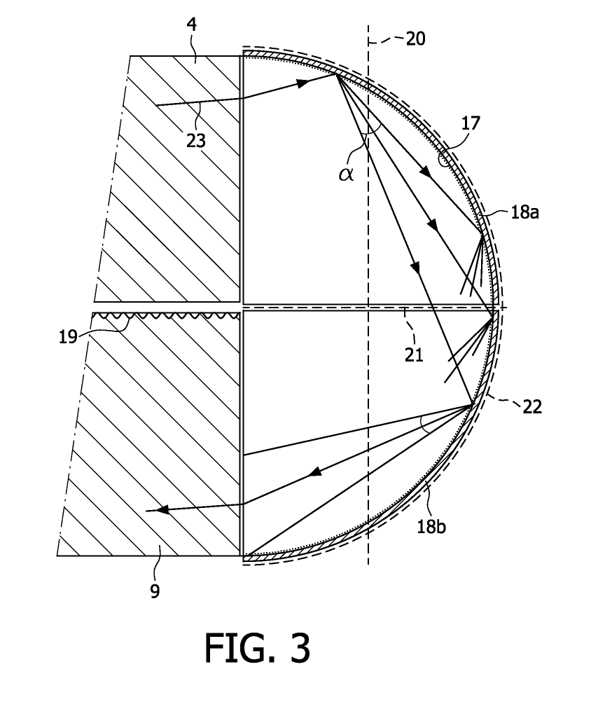

FIG. 3 is a cross-sectional view of the mirror of the illumination system of FIG. 2.

FIG. 1 shows an illumination system comprising two neighboring light sources of different color temperatures, for example fluorescent tubes (not shown), each emitting light beams with a unique light spectrum during operation, for example of 2700 K and 6500 K. The system further comprises an optical system 1 for guiding the light beams 2, 3, comprising a hollow transparent optical waveguide 4, for example made of glass, defining a longitudinal optical waveguide axis 5 and having a coupling-in face 6 and a coupling-out 7 face. A transition part 8, in the Figure two connected solid PMMA mirrors, connects the coupling-out face 7 of the optical waveguide 4 to a hollow transparent light extraction panel 9. The transparent light extraction panel 9 defines a longitudinal panel axis 10 and has an extraction structure 11 for coupling out light beams 2, 3 from the light sources to the exterior. Both the optical waveguide 4 and the light extraction panel 9 are specularly reflecting and the transition part 8 has a partly specular coating 13 that causes an increase in angular spread α of 6° upon reflection of the light beams compared with the specular direction of the reflected light beams. The light propagation from the optical waveguide 4 to the light extraction panel 9 occurs at a propagation angle of 0°, as is indicated by the arrows 2, 3, and A pointing in the same direction. The system is suspended from a ceiling and has a light-generating part (not shown) which, together with the optical waveguide 4, is hidden behind ceiling panels 12. The light extraction panel 9 is not hidden but visible. The light extraction structure 11 is a specularly reflecting Fresnel pattern.

FIG. 2 shows a second embodiment of the lighting system according to the invention. In the configuration of this embodiment as shown, the light propagation angle is 180°, indicated by the arrows 14, 15, 16 oppositely directed to arrow A. The light propagation angle of 180° is caused by reflection of the light beams by an open glass transition part 8 comprising two mirrors 18a, 18b, each with a chemically etched reflecting surface 17. Alternatively, the transition part comprises one integral mirror part only. The mirrors cause an increase in angular spread α of 20° upon reflection of light beams 14, 15, 16. Said light beams originate from a set of RGB LEDs (not shown). The solid PMMA optical waveguide 4 functions as a cover for the solid light extraction panel 9. The light extraction structure 19 is formed by printed dots of white paint. As the mirrors 18, 18b are mutually rotatable about a central, common transition axis 20 transverse to an interface 21 of the mirrors 18a, 18b, the light propagation angle is adjustable in a plane between 0° and 180°. It is obvious that the light propagation can be guided into any desired direction both in and out of a plane when the transition part comprises a plurality of, for example three, mutually rotatable mirrors.

FIG. 3 is a cross-sectional view of a detail of the illumination system of FIG. 2 showing part of the path of a light ray 23 from the optical waveguide 4 to the light extraction panel 9 via the transition part 8, finally to be coupled out from the light extraction panel via the light extraction structure 19. The transition part 8 comprises two open mirrors 18a, 1 8b which both have a chemically etched surface 17 to increase the angular spread α by 20° for each light ray impinging on said surface. The combination of said etched surface 17 with an aluminum reflecting layer 22 causes the mirrors to be substantially specularly reflecting. The mirrors 18a, 18b are rotatable with respect to one another about the axis 20, which is transverse to the interface 21 between both mirrors 18a, 18b. It is thus possible to move the propagation angle out of the plane of the drawing.

1. An illumination system comprising at least two neighboring light sources, and an optical system for channeling light beams emitted by the light sources, the optical system comprising:
an optical waveguide defining a longitudinal optical waveguide axis and having a coupling-in face and a coupling-out face,
a transparent light extraction panel defining a longitudinal panel axis and having an extraction structure for coupling out the light beams to the exterior, and
a substantially specularly reflecting transition part connecting the coupling-out face of the optical waveguide to the transparent light extraction panel, wherein the transition part facilitates an increase in angular spread α of at least 5° and at most 30° with respect to the specular direction of the light beams upon reflection thereof.

2. An illumination system as claimed in claim 1, wherein the transition part comprises at least one open reflection mirror.

3. An illumination system as claimed in claim 2, wherein light propagation from the optical waveguide to the light extraction panel occurs at a propagation able of about 0°.

4. An illumination system as claimed in claim 2, wherein light propagation from the optical waveguide to the light extraction panel occurs at a propagation angle of about 180°.

5. An illumination system as claimed in claim 1, wherein light propagation from the optical waveguide to the light extraction panel occurs at a propagation angle of about 90°.

6. An illumination system as claimed in claim 1, wherein the light sources are selected from the group consisting of: LEDs, fluorescent tubes, halogen lamps, and HID lamps.

7. An illumination system as claimed in claim 6, wherein the light sources emit light of different spectra.

8. An illumination system as claimed in claim 1, wherein the light extraction structure is a Fresnel grating.

9. An illumination system as claimed in claim 1, wherein the optical waveguide is made of PMMA or glass.

10. An illumination system as claimed in claim 1, wherein the transition part comprises at least two mutually rotatable deflection/refection mirrors.

11. An illumination system as claimed in claim 7, wherein the light sources emit light of different color temperatures ranging from 2500 K to 6500 K.
